(19) United States
(12) Patent Application Publication
(10) Pub. No.: US 2025/0113305 A1
(43) Pub. Date: Apr. 3, 2025

(54) WAVEFORM SWITCHING WITH CLOSED LOOP POWER CONTROL

(71) Applicant: Nokia Technologies Oy, Espoo (FI)

(72) Inventors: Amir Mehdi AHMADIAN TEHRANI, Munich (DE); Alessio MARCONE, Munich (DE); Nhat-Quang NHAN, Reims (FR); Marco MASO, Issy les Moulineaux (FR); Majed SAAD, Massy (FR); Karim KASAN, Massy (FR)

(21) Appl. No.: 18/898,571

(22) Filed: Sep. 26, 2024

Related U.S. Application Data
(60) Provisional application No. 63/586,884, filed on Sep. 29, 2023.

(51) Int. Cl. H04W 52/14; H04W 52/08; H04W 52/36

(52) U.S. Cl. CPC H04W 52/146; H04W 52/08; H04W 52/367

(57) ABSTRACT

Embodiments of the present disclosure relate to devices, methods, apparatuses, and computer readable storage media of uplink power control. A first apparatus receives a first DCI scheduling a first PUSCH transmission at a first TO, and a second DCI scheduling a second PUSCH transmission at a second TO subsequent to the first TO. The first apparatus determines a transmission power based on a second power control adjustment state and transmits the second PUSCH transmission at the second transmission power. The transmission power and/or the second power control adjustment state is determined based on at least one of: a first maximum transmission power at the first TO, a second maximum transmission power at the second TO, a value of the first TPI field of the first DCI, a value of the second TPI field in the second DCI or a first power control adjustment state for the first PUSCH transmission.

### FIELDS

Various example embodiments of the present disclosure generally relate to the field of telecommunication and in particular, to methods, devices, apparatuses and computer readable storage medium for dynamic waveform switching with closed loop power control.

### BACKGROUND

In communication systems, the uplink power control procedure determines transmit power of the different uplink physical channels, for example, Physical Uplink Control Channel (PUCCH) and Physical uplink shared channel (PUSCH), or signals, for example, Sounding Reference Signal (SRS), Physical Random Access Channel (PRACH), and so on.

In practice, it is often required to either increase or decrease the transmit power of user equipment (UE) or mobile device. This is known as uplink power control. Transmit power is increased to meet required Signal to Noise Ratio (SNR) or block error rate (BLER) at the network device. Transmit power is decreased to minimize co-channel interference of the communication system. There are two types of power controls i.e., open loop power control and closed loop power control. Power control is an important technique in communication systems to ensure the reliable and efficient transmission of data. By adjusting the transmit power level, it can improve the coverage and capacity of the network while reducing the interference to other cells or users.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, a first downlink control information (DCI), and a second DCI, the first DCI scheduling a first PUSCH transmission at a first transmission occasion (TO), and the second DCI scheduling a second PUSCH transmission at a second TO subsequent to the first TO, wherein the first DCI contains a first transform precoder indicator (TPI) field whose value indicates whether a transform precoder is enabled for the first PUSCH transmission, and the second DCI contains a second TPI field whose value indicates whether a transform precoder is enabled for the second PUSCH transmission; determine a transmission power for the second PUSCH transmission as a function of a second power control adjustment state, wherein at least one of the transmission power for the second PUSCH transmission or the second power control adjustment state for the second PUSCH transmission is determined based on at least one of: a first maximum transmission power at the first TO, a second maximum transmission power at the second TO, a value of the first TPI field of the first DCI, a value of the second TPI field in the second DCI or a first power control adjustment state for the first PUSCH transmission; and transmit the second PUSCH transmission at the determined transmission power for the second PUSCH transmission.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, a first DCI and a second DCI, the first DCI scheduling a first PUSCH transmission at a first TO and the second DCI scheduling a second PUSCH transmission at a second TO subsequent to the first TO, wherein the first DCI contains a first TPI field whose value indicates whether a transform precoder is enabled for the first PUSCH transmission, and the second DCI contains a second TPI field whose value indicates whether a transform precoder is enabled for the second PUSCH transmission; and receive, from the first apparatus, the second PUSCH transmission at a transmission power for the second PUSCH transmission, wherein the transmission power for the second PUSCH transmission is determined as a function of a second power control adjustment state, and wherein at least one of the transmission power for the second PUSCH transmission or the second power control adjustment state for the second PUSCH transmission is determined based on at least one of: a first maximum transmission power at the first TO, a second maximum transmission power at the second TO, a value of the first TPI field in the first DCI, a value of the second TPI field in the second DCI or a first power control adjustment state for the first PUSCH transmission.

In a third aspect of the present disclosure, there is provided a method. The method comprises: receiving, from a second apparatus, a first DCI and a second DCI, the first DCI scheduling a first PUSCH transmission at a first TO and the second DCI scheduling a second PUSCH transmission at a second TO subsequent to the first TO, wherein the first DCI contains a first TPI field whose value indicates whether a transform precoder is enabled for the first PUSCH transmission, and the second DCI contains a second TPI field whose value indicates whether a transform precoder is enabled for the second PUSCH transmission; determining a transmission power for the second PUSCH transmission as a function of a second power control adjustment state, wherein at least one of the transmission power for the second PUSCH transmission or the second power control adjustment state for the second PUSCH transmission is determined based on at least one of: a first maximum transmission power at the first TO, a second maximum transmission power at the second TO, a value of the first TPI field of the first DCI, a value of the second TPI field in the second DCI or a first power control adjustment state for the first PUSCH transmission; and transmitting the second PUSCH transmission at the determined transmission power for the second PUSCH transmission.

In a fourth aspect of the present disclosure, there is provided a method. The method comprises: transmitting, to a first apparatus, a first DCI and a second DCI, the first DCI scheduling a first PUSCH transmission at a first TO and the second DCI scheduling a second PUSCH transmission at a second TO subsequent to the first TO, wherein the first DCI contains a first TPI field whose value indicates whether a transform precoder is enabled for the first PUSCH transmission, and the second DCI contains a second TPI field whose value indicates whether a transform precoder is enabled for the second PUSCH transmission; and receiving, from the first apparatus, the second PUSCH transmission at a transmission power for the second PUSCH transmission, wherein the transmission power for the second PUSCH transmission is determined as a function of a second power control adjustment state, and wherein at least one of the transmission power for the second PUSCH transmission or the second power control adjustment state for the second PUSCH transmission is determined based on at least one of: a first maximum transmission power at the first TO, a second maximum transmission power at the second TO, a value of the first TPI field in the first DCI, a value of the second TPI field in the second DCI or a first power control adjustment state for the first PUSCH transmission.

In a fifth aspect of the present disclosure, there is provided a first apparatus. The first apparatus comprises means for receiving, from a second apparatus, a first DCI and a second DCI, the first DCI scheduling a first PUSCH transmission at a first TO and the second DCI scheduling a second PUSCH transmission at a second TO subsequent to the first TO, wherein the first DCI contains a first TPI field whose value indicates whether a transform precoder is enabled for the first PUSCH transmission, and the second DCI contains a second TPI field whose value indicates whether a transform precoder is enabled for the second PUSCH transmission; means for determining a transmission power for the second PUSCH transmission as a function of a second power control adjustment state, wherein at least one of the transmission power for the second PUSCH transmission or the second power control adjustment state for the second PUSCH transmission is determined based on at least one of: a first maximum transmission power at the first TO, a second maximum transmission power at the second TO, a value of the first TPI field of the first DCI, a value of the second TPI field in the second DCI or a first power control adjustment state for the first PUSCH transmission; and means for transmitting the second PUSCH transmission at the determined transmission power for the second PUSCH transmission.

In a sixth aspect of the present disclosure, there is provided a second apparatus. The second apparatus comprises means for transmitting, to a first apparatus, a first DCI and a second DCI, the first DCI scheduling a first PUSCH transmission at a first TO and the second DCI scheduling a second PUSCH transmission at a second TO subsequent to the first TO, wherein the first DCI contains a first TPI field whose value indicates whether a transform precoder is enabled for the first PUSCH transmission, and the second DCI contains a second TPI field whose value indicates whether a transform precoder is enabled for the second PUSCH transmission; and means for receiving, from the first apparatus, the second PUSCH transmission at a transmission power for the second PUSCH transmission, wherein the transmission power for the second PUSCH transmission is determined as a function of a second power control adjustment state, and wherein at least one of the transmission power for the second PUSCH transmission or the second power control adjustment state for the second PUSCH transmission is determined based on at least one of: a first maximum transmission power at the first TO, a second maximum transmission power at the second TO, a value of the first TPI field in the first DCI, a value of the second TPI field in the second DCI or a first power control adjustment state for the first PUSCH transmission.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example communication environment in which example embodiments of the present disclosure can be implemented;

FIG. 1B illustrates a diagram of a case when dynamic waveform switching (DWS) feature is used with closed loop power control (CLPC);

FIG. 2 illustrates a signaling chart for uplink power control according to some example embodiments of the present disclosure;

FIG. 3 illustrates a signaling chart for uplink power control according to further example embodiments of the present disclosure;

FIG. 4 illustrates a signaling chart for uplink power control according to further example embodiments of the present disclosure;

FIG. 5 illustrates a signaling chart for uplink power control according to further example embodiments of the present disclosure;

FIG. 6 illustrates a signaling chart for uplink power control according to further example embodiments of the present disclosure;

FIG. 7 illustrates a flowchart of a method implemented at a first apparatus according to some example embodiments of the present disclosure;

FIG. 8 illustrates a flowchart of a method implemented at a second apparatus according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

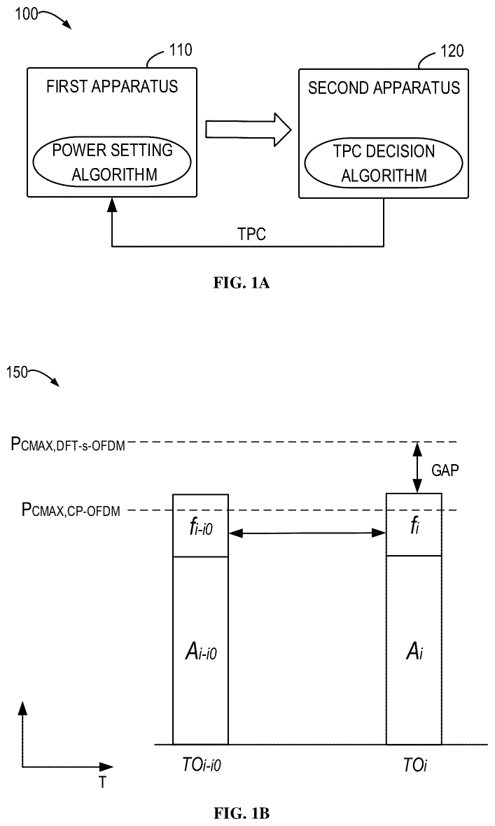

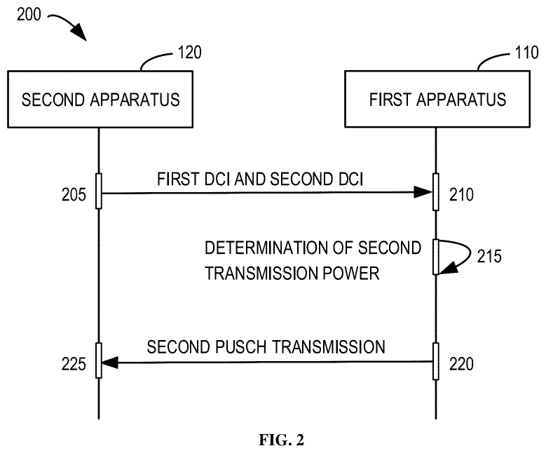

FIG. 1A illustrates an example communication environment 100 in which example embodiments of the present disclosure can be implemented. As shown in FIG. 1, the communication network 100 may comprise a first apparats 110, which may be, for example, a terminal device. Hereinafter the first apparats 110 may also be referred to as a UE in some example embodiments.

The communication network 100 may further comprise a second apparats 120, which may be, for example, a network device. In some example embodiments, the second apparatus 120 may also be referred to as a BS, a gNB, or an eNB. The first apparats 110 may communicate with the second apparatus 120 within a coverage of the second apparatus 120, for example, the geographical area of the first apparats 110 is served by a satellite beam or cell from the second apparatus 120.

It is to be understood that the number of network devices and terminal devices shown in FIG. 1A is given for the purpose of illustration without suggesting any limitations. The communication network 100 may include any suitable number of network devices and terminal devices.

In the following, for the purpose of illustration, some example embodiments are described with the first apparatus 110 operating as a terminal device and the second apparatus 120 operating as a network device. However, in some example embodiments, operations described in connection with a terminal device may be implemented at a network device or other device, and operations described in connection with a network device may be implemented at a terminal device or other device.

In some example embodiments, if the first apparatus 110 is a terminal device and the second apparatus 120 is a network device, a link from the second apparatus 120 to the first apparatus 110 is referred to as a downlink (DL), and a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As discussed above, there are two types of power controls i.e., open loop power control and closed loop power control. In the Open Loop Power Control (OLPC), there is no feedback either from the first apparatus (e.g., UE) to a second apparatus (e.g., gNB) or from gNB to UE. Whereas, in the Closed Loop Power Control (CLPC), the UE power is controlled dynamically by Transmission Power Control (TPC) command (MAC CE or TPC field in DCI 0_0/0_1, DCI Format 2_2 or UL grant via Msg2 during Initial Access). It means UE Transmission Power is controlled by some direct input provided by gNB based, for instance, on previous UL measurements or previous reports received by UE and so on. As such, overall power control process forms a loop (closed loop). With CLPC, each UE in the cell receives the command from the gNB to increase/decrease the transmission power or keep it constant (e.g., in case it is already at optimal level). This type of power control solves the problem of unoptimized (too low or too high) UL power. In general, this fields beneficial effects on the considered link, e.g., increasing its budget and robustness, and/or on other links, e.g., reducing interference level.

The determination of uplink (UL) power control will be descried below. If a user equipment (UE) transmits a physical uplink shared channel (PUSCH) on active UL bandwidth part (BWP) b of carrier f of serving cell c using parameter set configuration with index j and PUSCH power control adjustment state with index l and reference signal (RS) resource index q_{d}, the UE determines the PUSCH transmission power P_{PUSCH,b,f,c}(i, j, q_{d}, l) in PUSCH transmission occasion (TO) i according to the following equation:

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + \\ 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + \\ {Δ}_{TF , b , f , c} ( i ) + {f}_{b , f , c} ( i , l )\end{matrix}\end{matrix} \} [ dBm ] \qquad ( 1 )$$

where:
P_{CMAX,f,c}(i) is the UE configured maximum output power for carrier f of serving cell c in PUSCH transmission occasion i,
P_{O_PUSCH,b,f,c}(j) is a parameter composed of the sum of a component P_{O_NOMINAL,PUSCH,f,c}(j) and a component P_{O_UE_PUSCH,b,f,c}(j) where jϵ{0, 1, . . . , J−1},
μ is related to the configured new radio (NR) numerology (subcarrier spacing),
M_{RB,b,f,c}^{PUSCH} depicts bandwidth of the PUSCH resource assignment expressed in number of allocated resource blocks for PUSCH,
α_{b,f,c} is a power adjustment factor determined by at least one of the following: msg3-Alpha, ConfiguredGrantConfig, p0-PUSCH-alpha, p0-PUSCH-alphaSet, SRI-PUSCHPowerControl, Send Routing Information (SRI) field in downlink control information (DCI) format 0_0/0_1,
PL_{b,f,c}(q_{d}) is a downlink pathloss estimates in dB calculated by the UE using reference signal (RS) resource index q_{d} on active UL BWP b of carrier f of serving cell c,
Δ_{TF,b,f,c} is the modulation and coding scheme (MCS) offset, adjusting the power control to the used MCS. If gNB dynamically adjusts MCS to compensate for changes on the channel quality or conditions, this term can be set to 0. However, when gNB does not use MCS adaptation for dynamic channel condition compensation, gNB may instruct UE to adjust PUSCH transmission power according to MCS, i.e., to increase Tx power for higher MCS values. The MCS offset is given by Δ_{TF,b,f,c}=10 log₁₀((2^{BPRE·1.25}−1)) for single layer PUSCH containing UL-SCH data. The equation is an approximation based on the Shannon's Capacity Theorem (C=B log₂(1+SINR)), from which Signal to Interference plus Noise Ratio (SINR) is solved with assumption that NR achieves 80% of ideal Shannon capacity. The Bits Per Resource Element (BPRE) is given by BPRE=Σᵣ₌₀^{C-1}Kᵣ/N_{RE} where C is the number of transmitted code blocks, Kᵣ is the size of code block r, and N_{RE} is a number of resource elements allocated for the PUSCH, excluding the resource elements used for Demodulation Reference Signal (DMRS) and phase tracking reference signal.
f_{b,f,c}(i, l) is PUSCH power control adjustment state for active UL BWP b of carrier f of serving cell c and transmission occasion i that may accumulate transmission power control (TPC) command value,
the PUSCH transmission power is capped by P_{CMAX,f,c}(i), which is defined as the UE maximum output power for a given waveform/configuration. UE can set the P_{CMAX,f,c} value in each slot, as long as the P_{CMAX,f,c} is set within the bounds:

P_{CMAX_L,f,c}≤P_{CMAX,f,c}≤P_{CMAX_H,f,c},
where P_{CMAX_L,f,c}=MIN {P_{EMAX,c}−ΔT_{C,c}, (P_{PowerClass}−ΔP_{PowerClass})−MAX(MAX(MPR_{c}+ΔMPR_{c}, A−MPR_{c})+ΔT_{IB,c}+ΔT_{C,c}+ΔT_{RxSRS}, P-MPR_{c})} and P_{CMAX_H,f,c}=MIN {P_{EMAX,c}, P_{PowerClass}−ΔP_{PowerClass}}.

Particularly interesting for the present disclosure is the last term of the PC equation (i.e., f_{b,f,c}(i, l)), typically referred to as PUSCH power control adjustment state. For the PUSCH power control adjustment state of active UL BWP b of carrier f of serving cell c in PUSCH TOᵢ, δ_{PUSCH,b,f,c}(i, l) is a TPC command value included in a DCI format that schedules the PUSCH TOᵢ on active UL BWP b of carrier f of serving cell c or jointly coded with other TPC commands in a DCI format 2_2 with CRC scrambled by a radio network temporary identifier (RNTI) called TPC-PUSCH-RNTI, and is fundamental in the calculation of f_{b,f,c}(i, l) as f_{b,f,c}(i, l)=f_{b,f,c}(i−i₀, l)+Σₘ₌₀^{C(D}^{ᵢ}⁾⁻¹δ_{PUSCH,b,f,c}(m, l). In particular, Σₘ₌₀^{C(D}^{ᵢ}⁾⁻¹ δ_{PUSCH,b,f,c}(m, l) is a sum of TPC command values in a set Dᵢ of TPC command values with cardinality C(Dᵢ) that the UE receives between K_{PUSCH}(i−i₀)−1 symbols before PUSCH TOᵢ₋ᵢ_{₀} and K_{PUSCH}(i) symbols before PUSCH TOᵢ on active UL BWP b of carrier f of serving cell c for PUSCH power control adjustment state l, where i₀>0 is the smallest integer for which K_{PUSCH}(i−i₀) symbols before PUSCH TOᵢ₋ᵢ_{₀} is earlier than K_{PUSCH}(i) symbols before PUSCH TOᵢ. For the case of a PUSCH transmission scheduled by a DCI format, K_{PUSCH}(i) is a number of symbols for active UL BWP b of carrier f of serving cell c after a last symbol of a corresponding PDCCH reception and before a first symbol of the PUSCH transmission.

For example, for two PUSCH TOs (i=0 and i=1) scheduled by two PDCCH at time t0 and t1 with t1>t0, i₀=1, K_{PUSCH}(0) symbols before PUSCH TO, is earlier than K_{PUSCH}(1) symbols before PUSCH TO₁. In this case, Σₘ₌₀^{C(D}^{ᵢ}⁾⁻¹ δ_{PUSCH,b,f,c}(m, l) is a sum of TPC command values in a set Dᵢ of TPC command values with cardinality C(Dᵢ) that the UE receives between K_{PUSCH}(0) symbols before PUSCH TO₀ and K_{PUSCH}(1) symbols before PUSCH TO₁.

In an existing design, waveform is RRC configured. However, a dynamic (fast) switch from cyclic prefix OFDM (CP-OFDM) to discrete Fourier transform spread orthogonal frequency division multiplexing (DFT-s-OFDM) is beneficial in coverage shortage given the robustness of the latter in terms of Peak to Average Power Ratio (PAPR). Therefore, a feature is defined, which often referred to as dynamic switching between DFT-s-OFDM and CP-OFDM (or dynamic waveform switching). This feature allows network to indicate in a scheduling DCI (with format 0_1 or 0_2) the waveform to be applied for a PUSCH transmission scheduled by the DCI. In other words, the DCI indicates whether transform precoder is enabled or disabled for the PUSCH transmission. The feature is enabled when a dynamic transform precoder indication information element (e.g., dynamicTransformPrecoderIndicationDCI-0-1 in pusch-Config for DCI format 0_1 or dynamicTransformPrecoderIndicationDCI-0-2 in pusch-Config for DCI format 0_2) is configured and set to enabled in PUSCH-Config information element of the BWP where the DCI is received. When the feature is enabled, a transform precoder indicator (TPI) field is present in the DCI. Transform precoder is enabled (i.e., DFT-s-OFDM is applied) for the PUSCH transmission scheduled by the DCI when the TPI field value is set to 0. Transform precoder is disabled (i.e., CP-OFDM is applied) for the PUSCH transmission scheduled by the DCI when the (TPI) field value is set to 1.

FIG. 1B illustrates a diagram 150 of an example of the issue when dynamic waveform switching (DWS) feature is used with closed loop power control (CLPC).

Denote Aᵢ=P₀_{_{PUSCH,b,f,c}}(j)+10 log₁₀(2^{μ}·M_{RB,b,f,c}^{PUSCH}(i))+α_{b,f,c}(j). PL_{b,f,c}(q_{d})+Δ_{TF,b,f,c}(i). It can be observed from FIG. 1B that, if a UE was indicated with cyclic prefix OFDM (CP-OFDM) (i.e, TPIfield=1) and reached maximum transmit power for a PUSCH transmission at TOᵢ₋ᵢ_{₀}, and the UE is then indicated with DFT-s-OFDM (i.e., TPI field=0) for another PUSCH transmission at TOᵢ, the UE could not transmit with max power of discrete Fourier transform spread orthogonal frequency division multiplexing (DFT-s-OFDM) for the PUSCH transmission at TOᵢ due to a restriction that fᵢ must be equal to fᵢ₋ᵢ₀ in this case. In other words, any TPC command received for boosting power for the PUSCH transmission at TOᵢ could not be accumulated. This would invalidate the benefit brought by the DWS feature at TOᵢ i.e., exploiting the power gap offered by DFT-s-OFDM waveform, as shown in FIG. 1B. Note that this example assumes the max power of DFT-s-OFDM is higher than that of CP-OFDM, which is the main motivation for DWS to DFT-s-OFDM at TOᵢ. Note also that we assume Aᵢ=Aᵢ₋ᵢ₀ in this example (i.e., a lower bound for the gap). However, in practice, the gNB would apply smaller number of resource blocks and MCS in case of switching from CP-OFDM to DFT-s-OFDM (due to coverage shortage anticipation), which leads to Aᵢ<Aᵢ₋ᵢ₀, and thus a bigger gap could not be exploited.

As mentioned above, an issue with dynamic waveform switching (DWS) with CLPC is that, if waveform is dynamically switched at transmission occasion i but UE reaches the maximum transmission power for active UL BWP b of carrier f of serving cell c at PUSCH transmission occasion i−i₀ (we will refer to it as TO as well in the remainder of this IR) TOᵢ₋ᵢ_{₀} and, at the same time, the TPC determined power control adjustment is greater than or equal to zero, UE must set f_{b,f,c}(i, l)=f_{b,f,c}(i−i₀, l) for TOᵢ even though the TPC command in the downlink control information (DCI) scheduling TOᵢ may be larger than 0. Indeed, there exists a rule that: If the UE has reached maximum power for active UL BWP b of carrier f of serving cell c at PUSCH transmission occasion i−i₀ and Σₘ₌₀^{C(D}^{ᵢ}⁾⁻¹δ_{PUSCH,b,f,c}(m, l)≥0, then f_{b,f,c}(i, l)=f_{b,f,c}(i−i₀, l).

To avoid the above restriction, one approach could be to follow current specifications for a first TO after DWS so that when a second consecutive TO of the new waveform (if any) occurs, the power in the first TO would not be at maximum level (max power) anymore so that f_{b,f,c}(i, l) could restart increasing. However, this approach would be against the main benefits coming from dynamic waveform switching feature in which, using TPI field in the DCI, UE should be able to switch waveform at each TO and exploit the gain in maximum available power dynamically with the switch. As such according to current specification, the UE must experience at least two consecutives TOs of the same waveform to fully exploit the expected advantages of waveform switching in a coverage limited scenario (i.e., the maximum transmission power advantage).

In this context, the above mentioned equation (1) is such that UE may reach Pcmax regardless the limitation of f_{b,f,c}(i, l) in current specification if the number of the PRBs allocated for the PUSCH, i.e., M_PRB, or the MCS index is increased. Increasing M_PRB allocation is a possible approach, however it could lead to a worse coverage even with DWS due to the coarse PRB allocation granularity with DFT-S-OFDM since the allocation should be increased at least by 2 RBs to respect the following rule with DFT-S-OFDM: #RB=2^{a}3^{b}5^{c}. In addition, the non-ideal granularity of the configurable MCS indices set may not be able to offer suitable values to compensate the EPRE reduction brought by the larger number of allocated PRBs for the PUSCH, and MCS index could be already low so a smaller MCS could be not possible (this depends on the link adaptation strategies at gNB on the considered number of PRBs). Similarly, an MCS increase may allow to reach Pcmax of DFT-S-OFDM, but it is not preferred approach in a low coverage scenarios.

Given the benefit of dynamic waveform switching feature (using the TPIfield) and the possibility of using dynamic waveform switching feature together with closed loop power control between UE and gNB at each TO, means for enabling waveform switching to DFT-S-OFDM at any TO without any restriction on UL power transmission (at maximum level) have not been specified/discussed (nor precluded-they can be proposed). Embodiments of the present disclosure mainly focus on resolving above issues to fill in the gap enabling switching waveform to DFT-S-OFDM while closed loop power control is applied between UE and gNB without any restriction on UE UL power transmission level.

Example embodiments of the present disclosure will be described in detail below with reference to the accompanying drawings. Reference is now made to FIG. 2, which shows a signaling chart 200 for uplink power control according to some example embodiments of the present disclosure. As shown in FIG. 2, the signaling chart 200 involves a first apparatus 110 and a second apparatus 120. For the purpose of discussion, reference is made to FIG. 1A to describe the signaling chart 200. Although a single first apparatus 110 is illustrated in FIG. 2, it would be appreciated that there may be a plurality of terminal devices performing similar operations as described with respect to the first apparatus 110 below.

As shown in FIG. 2, the second apparatus 120 transmits (205) a first DCI and a second DCI to the first apparatus 110. The first DCI schedules a first PUSCH transmission at a first transmission occasion (TO), and the second DCI schedules a second PUSCH transmission at a second TO subsequent to the first TO. The first DCI contains a first TPI field whose value indicates whether a transform precoder is enabled for the first PUSCH transmission, and the second DCI contains a second TPI field whose value indicates whether a transform precoder is enabled for the second PUSCH transmission.

The first apparatus 110 receives (210) the first DCI and the second DCI, and determines (215) a transmission power for the second PUSCH transmission as a function of a second power control adjustment state. The transmission power and/or the second power control adjustment state for the second PUSCH transmission is determined based a variety of factors, for example, but not limited to, a first maximum transmission power at the first TO, a second maximum transmission power at the second TO, a value of the first TPI field of the first DCI, a value of the second TPI field in the second DCI or a first power control adjustment state for the first PUSCH transmission.

As used herein, the terms “transmission power” and “transmit power” can be used interchangeably. Both of the terms refer to the power for transmitting signals.

Then, the first apparatus 110 transmits (220) the second PUSCH transmission at the determined transmission power to the second apparatus 120. Accordingly, the second apparatus 120 receives (225), from the first apparatus 110, the second PUSCH transmission at a the transmission power determined at 215.

There are various ways for the first apparatus 110 to determine the transmission power and/or the second power control adjustment state at 215.

In some example embodiments, the second power control adjustment state may be first determined and then the transmission power is computed based thereon. Specifically, if the first apparatus 110 reached the first maximum transmission power at the first TO, and the value of the TPI field of the second DCI indicates that a transform precoder is enabled for the second PUSCH transmission, the first apparatus 110 may further determine whether the first apparatus would reach the second maximum transmission power at the second TO in the case that the second power control adjustment state is set as equal to the first power control adjustment state. If so, the first apparatus 110 may determine the second power control adjustment state to be equal to the first power control adjustment state. Then, the first apparatus 110 may compute the transmission power based on the determined second power control adjustment state. On the other hand, if the first apparatus 110 would not reach the second maximum transmission power at the second TO, the first apparatus 110 may determine the second power control adjustment state to be equal to a sum of the first power control adjustment state and a first adjustment value.

As an alternative, in some example embodiments, the transmission power may be computed directly. For instance, if the first apparatus 110 reached the first maximum transmission power at the first TO, and that the value of the TPI field of the second DCI indicates that a transform precoder is enabled for the second PUSCH transmission, the first apparatus 110 determines whether the first apparatus 110 would reach the second maximum transmission power at the second TO in the case that the second power control adjustment state is set as equal to the first power control adjustment state.

If the first apparatus 110 would not reach the second maximum transmission power at the second TO, the first apparatus 110 may determine the transmission power based on the second power control adjustment state and the first adjustment value, whereby the second power control adjustment state is equal to the first power control adjustment state.

The first adjustment value may be defined or configured or computed in various ways. In some example embodiments, the first adjustment value may be a first predefined value, which may be for example fixed in specification, for instance, the first adjustment value may be defined as 1. Alternatively, the first adjustment value may be a first configured value that is configured via a higher-layer signaling, for example, a RRC signaling.

As a further alternative, the first adjustment value may be computed by several means. For example, the first adjustment value may be a value (also referred to as “a first computed value” computed by adding a number of TPC command values received via DCI over a period of time. Alternatively, the first adjustment value may be another value (also referred to as “a second computed value”) computed based on the first maximum transmission power and the second maximum transmission power.

It is to be understood that the above examples of the first adjustment value are just discussed for illustration, rather than suggesting any limitation. In other example embodiments of the present disclosure, any other suitable values may be applicable for the first adjustment value.

As a further alternative, in some example embodiments, if the first apparatus 110 reached the first maximum transmission power at the first TO, the first apparatus 110 may determine whether a value of the TPI field (also referred to as “first TPI field”) of the first DCI is equal to the value of the TPI field (also referred to as “second TPI field”) of the second DCI. If the value of the first TPI field is equal to the value of the second TPI field, the first apparatus 110 may determine the second power control adjustment state to be equal to the first power control adjustment state. On the other hand, if the value of the TPI field of the first DCI is different from the value of the TPI field of the second DCI, the first apparatus 110 may determine the second power control adjustment state to be equal to a sum of the first power control adjustment state and a second adjustment value.

Alternatively, in some example embodiments, if the first apparatus 110 reached the first maximum transmission power at the first TO, the first apparatus 110 may determine whether a value of the TPI field of the first DCI is equal to the value of the TPI field of the second DCI. If the value of the TPI field of the first DCI is different from the value of the TPI field of the second DCI, the first apparatus 110 may determine the transmission power based on the second power control adjustment state and the second adjustment value, whereby the second power control adjustment state is equal to the first power control adjustment state.

In some example embodiments, the second adjustment value may be a second predefined value, for instance, fixed in specification. Alternatively, a second configured value that is configured via a higher-layer signaling. As a further alternative, the second adjustment value may be a third computed value determined by adding a number of TPC command values received via DCI over a period of time, or a fourth computed value determined based on the first maximum transmission power and the second maximum transmission power. It is to be understood that the above examples of the second adjustment value are just discussed for illustration, rather than suggesting any limitation. In other example embodiments of the present disclosure, any other suitable values may be applicable for the second adjustment value.

In some example embodiments, if the first apparatus 110 reached the first maximum transmission power at the first TO, and the first maximum transmission power at the first TO is greater than or equal to a third maximum transmission power that would be applied by the first apparatus 110 in case a transform precoder is enabled for the first PUSCH transmission, the first apparatus 110 may determine the second power control adjustment state to be equal to the first power control adjustment state.

Alternatively, if the first apparatus 110 reached a sum of the first maximum transmission power at the first TO and a third adjustment value, the first apparatus 110 may determine the second power control adjustment state to be equal to the first power control adjustment state.

The third adjustment value may be a third predefined value, a third configured value configured via a higher-layer signaling, e.g., a RRC signaling, and/or other suitable value.

In some example embodiments, the second apparatus 120 may transmit, to the first apparatus 110, a higher-layer signaling comprising a first configured value for a first adjustment value, a second configured value for a second adjustment value, and/or the like. As such, the first apparatus 110 can obtain the first configured value and/or the second configured value from the second apparatus 120.

In this way, the gap enabling switching waveform to DFT-S-OFDM while closed loop power control is filled between UE and gNB without any restriction on UE uplink power transmission level.

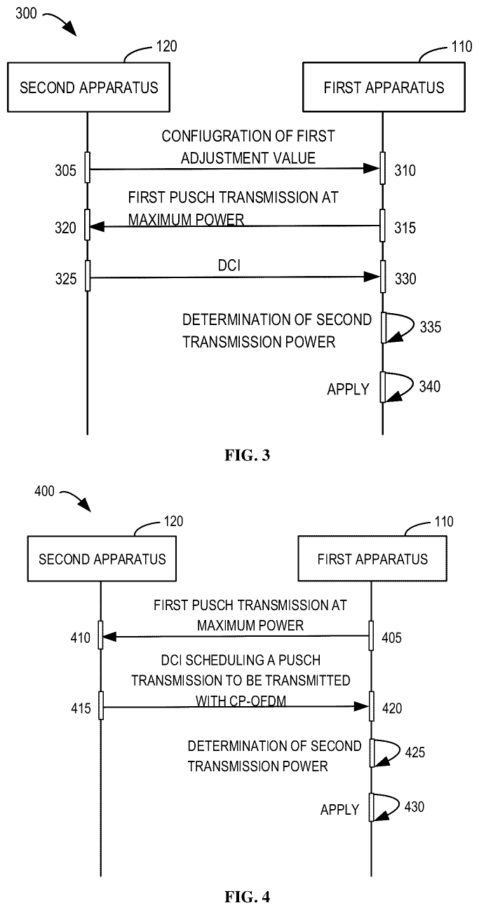

More example embodiments of uplink power control will be discussed in details with respect to with reference to FIGS. 3-6. In the following example embodiments, the first apparatus 110 is sometimes referred to as “UE” and the second apparatus 120 is sometimes referred to as “gNB”.

In example embodiments of the present disclosure, a DWS specific condition is proposed before a UE sets f_{b,f,c}(i, l). It is assumed that the dynamic waveform switching feature is enabled. That is, the UE is configured with a higher layer parameter dynamicTransformPrecoderIndicationDCI-0-1 in pusch-Config for DCI format 0_1 or dynamicTransformPrecoderIndicationDCI-0-2 in pusch-Config for DCI format 0_2, and the higher layer parameter is set to “enabled”.

As used herein, the term DFT-s-OFDM may also be referred to as “transform precoder is enabled”, and the term CP-OFDM may also be referred to as “transform precoder is disabled”. When the dynamic waveform switching feature is enabled, the “transform precoder indicator” field is present in the DCI for all TOs. For example, if the “transform precoder indicator” field is set to 0 in the DCI that schedules a PUSCH transmission at TOᵢ, the UE applies DFT-s-OFDM for the PUSCH transmission. If the “transform precoder indicator” field is set to 1 in the DCI that schedules a PUSCH transmission at TOᵢ, the UE applies CP-OFDM for the PUSCH transmission.

In some example embodiments, the PUSCH transmission at TOᵢ₋ᵢ_{₀} (first TO) is referred to as the “first PUSCH transmission”. The PUSCH transmission at TOᵢ (second TO) is referred to as the “second PUSCH transmission”. TOᵢ is a time occasion subsequent to TOᵢ₋ᵢ_{₀}. The first DCI schedules the PUSCH transmission at TOᵢ₋ᵢ_{₀} and the second DCI schedules the PUSCH transmission at TOᵢ. The transmission power to be used for the second PUSCH transmission may be determined based on a maximum transmission power (also referred to as “first maximum transmission power”) at TOᵢ₋ᵢ_{₀}, a maximum transmission power (also referred to as “second maximum transmission power”) at TOᵢ, a value of the first TPI field of the first DCI, a value of the second TPI field in the second DCI or a first power control adjustment state for the PUSCH transmission at TOᵢ₋ᵢ_{₀}, and/or the like.

In some example embodiments, the maximum power at TOᵢ is the P_{CMAX,f,c}(i) that corresponds to the waveform indicated at the TO. This depends on the transform precoder indicator field in the DCI that schedules a PUSCH transmission at TOᵢ.

Example embodiments provide a variety of solutions for uplink power control. In a first solution, if UE reached maximum power at TOᵢ₋ᵢ_{₀} and transform precoder indicator field is set to 0 at TOᵢ, UE sets f_{b,f,c}(i, l)=f_{b,f,c}(i−i₀, l) if it reaches maximum power at TOᵢ by using f_{b,f,c}(i, l)=f_{b,f,c}(i−i₀, l). Otherwise, f_{b,f,c}(i, l)=f_{b,f,c}(i−i₀, l)+a.

The value a represents the first adjustment value as discussed above. In one example, the value a may be fixed, e.g., a=1. In another example, the value a may be configurable by NW via RRC. In a further example, the network (NW) provides suitable, TPC command values using legacy DCI formats and a=Σₘ₌₀^{C(D}^{ᵢ}⁾⁻¹ δ_{PUSCH,b,f,c}(m, l), as defined above. In a still further example, the value a may be computed by UE, e.g., subtracting P_{CMAX,f,c}(i−i₀) calculated at TOᵢ₋ᵢ_{₀} to P_{CMAX,f,c}(i) calculated at TOᵢ. It should be noted that a can also be added directly in equation (1) of P_PUSCH. The first solution will be described in detail below with reference to FIG. 3.

In a second solution according to some example embodiments of the present disclosure, if UE reached max power at TOᵢ₋ᵢ_{₀} and only if Transform precoder indicator field is set to the same value at TOᵢ and TOᵢ₋ᵢ_{₀}, UE sets f_{b,f,c}(i, l)=f_{b,f,c}(i−i₀, l). It should be understood that this solution has the advantage that whenever the value of the Transform precoder indicator field set at TO; is different from the value set at TOᵢ₋ᵢ_{₀}, the limit on Tx power does not apply.

Otherwise, if UE reached max power at TOᵢ₋ᵢ_{₀} and if Transform precoder indicator field set at TOᵢ and TOᵢ₋ᵢ_{₀} is different, UE may set f_{b,f,c}(i, l)=f_{b,f,c}(i−i₀, l)+β. The value β represents the second adjustment value as discussed above.

In one example, β may be fixed, e.g., β=1. In another example, β may be configurable by NW via RRC. In a further example, NW provides suitable TPC command values using legacy DCI formats and β=Σₘ₌₀^{C(D}^{ᵢ}⁾⁻¹ δ_{PUSCH,b,f,c}(m, l)≥0, as defined above. In a still further example, β may be computed by UE, e.g., β=P_{cmax}^{DFT-s-OFDM}−P_{cmax}^{CP-OFDM}, or β=P_{cmax}^{CP-OFDM}−P_{cmax}^{DFT-s-OFDM}, where P_{cmax}^{CP-OFDM} and P_{cmax}^{DFTsOFDM} are the maximum output power for CP-OFDM and DFT-s-OFDM respectively for a given configuration and MPR/A-MPR/P-MPR values. It should be noted that β could also be added directly in equation (1) of P_PUSCH or within another parameter in P_PUSCH equation (1).

In some example embodiments, if DFT-s-OFDM is indicated in TOᵢ, β=P_{cmax}^{DFT-s-OFDM}−P_{cmax}^{CP-OFDM} and provides an implicit transmit power increase to boost the coverage immediately without the need for at least one explicit TPC commands. If CP-OFDM is indicated in TOᵢ, β=P_{cmax}^{CP-OFDM}−P_{cmax}^{DFT-s-OFDM} provides an implicit power decrease to satisfy CP-OFDM maximum power constraint without the need for one or more explicit TPC commands. Both variants of β may be calculated by UE and also estimated by gNB, if the latter received a PHR carrying information related to both waveforms. The second solution will be described in detail below with reference to FIGS. 4-5.

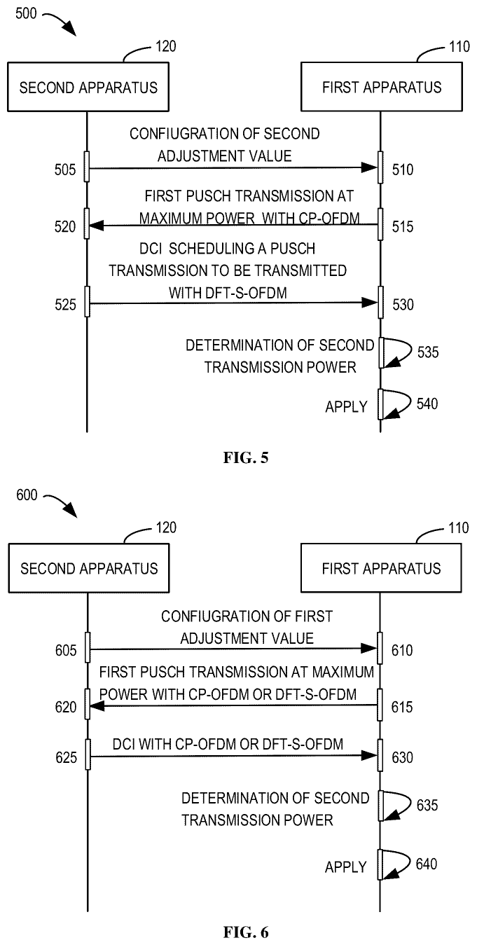

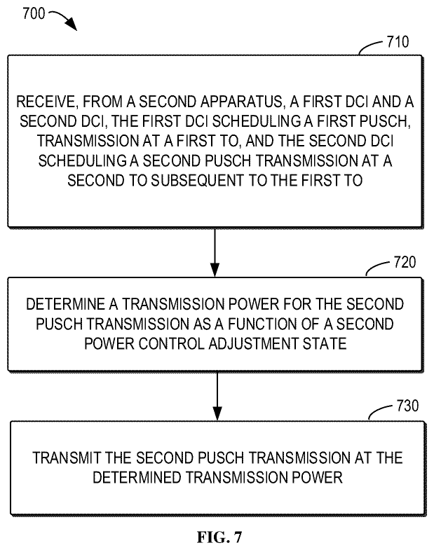

In a third solution according to some example embodiments of the present disclosure, if UE reached max power at TOᵢ₋ᵢ_{₀}, then UE sets f_{b,f,c}(i, l)=f_{b,f,c}(i−i₀, l) for TOᵢ if and only if the maximum power used for the transmission at TOᵢ₋ᵢ_{₀} does not depend on the configured waveform. This can occur, for instance, when the limiting factor of Pcmax is a factor other than the maximum power reduction (MPR), e.g., adaptive maximum power reduction (A-MPR)/P-MPR (due to specific absorption ratio (SAR) considerations, duty cycle exceedance, carrier aggregation (CA) operations and so on). In this case, the max power for the transmission would be the same irrespective of whether the UE transmits with DFT-s-OFDM or CP-OFDM. The second solution will be described in detail below with reference to FIG. 6.

Now reference is made to FIG. 3, which illustrates a signaling chart 300 for dynamic waveform switching according to some example embodiments of the present disclosure. In the following, for the purpose of illustration, some example embodiments are described with reference to FIG. 1 with the first apparatus 110 operating as a UE, and the second apparatus 120 operating as a gNB.

The second apparatus 120 transmits (305) configuration of first adjustment value to the first apparatus 110 via an RRC configuration. For example, this configuration of first adjustment value may comprise parameter a, and/or UL closed loop power control with P_PUSCH. At least one TOᵢ is configured such that Transform precoder indicator field is present in the DCI and parameter a may set to indicate f_{b,f,c}(i, l) at TOᵢ. The first apparatus 110 receives (310) this configuration, and transmits (315) first PUSCH transmission (e.g., PUSCH TOᵢ₋ᵢ₀) at maximum power to the second apparatus 120.

The second apparatus 120 receives (320) the first PUSCH transmission, and transmits (325) DCI to the first apparatus 110 so as to schedules TO. The first apparatus 110 receives (330) the DCI and determines (335) a second transmission power. For example the first apparatus 110 determines f_{b,f,c}(i, l) based on transmission power at TOᵢ. For example, from TPC command of the DCI scheduling TOᵢ, the first apparatus 110 determines Σₘ₌₀^{C(D}^{ᵢ}⁾⁻¹ δ_{PUSCH,b,f,c}(m, l)≥0. If the first apparatus 110 reached maximum power at TOᵢ₋ᵢ_{₀} and the first apparatus 110 has transmitted at maximum power for TOᵢ and Transform precoder indicator field is set to 0, the first apparatus 110 sets f_{b,f,c}(i, l)=f_{b,f,c}(i−i₀, l) for TOᵢ. Otherwise, if the first apparatus 110 has not transmitted at maximum power for TOᵢ or Transform precoder indicator field is not set to 0 in the scheduling DCI field f_{b,f,c}(i, l)=f_{b,f,c}(i−i₀, l)+a.

The first apparatus 110 applies (340) the determined UE operation mode (i.e. waveform and power) for the next UL transmission (e.g., new waveform).

FIG. 4 illustrates a signaling chart 400 for dynamic waveform switching according to some example embodiments of the present disclosure. In the following, for the purpose of illustration, some example embodiments are described with reference to FIG. 1 with the first apparatus 110 operating as a UE, and the second apparatus 120 operating as a gNB.

The first apparatus 110 transmits (405) first PUSCH transmission at maximum power to the second apparatus 120. For example, the first apparatus 110 transmits PUSCH TOᵢ₋ᵢ₀ with CP-OFDM as waveform and at maximum power for CP-OFDM. The second apparatus 120 receives (410) the first PUSCH transmission at maximum power and transmits (415) a DCI that schedules a PUSCH transmission to be transmitted with CP-OFDM to the first apparatus 110. For example, the second apparatus 120 schedules a PUSCH transmission at TOᵢ by transmitting a DCI indicating the same waveform at TOᵢ compared to TOᵢ₋ᵢ_{₀}, i.e. CP-OFDM for TOᵢ. The first apparatus 110 receives (420) the DCI and determines (425) a second transmission power. For example, the first apparatus 110 determines f_{b,f,c}(i, l) based on transmission power at TOᵢ. By way of example, from TPC command of the DCI scheduling TO, the first apparatus 110 determines Σₘ₌₀^{C(D}^{ᵢ}⁾⁻¹ δ_{PUSCH,b,f,c}(m, l)≥0, and sets f_{b,f,c}(i, l)=f_{b,f,c}(i−i₀, l) for TOᵢ even if UE has transmitted at maximum power for TOᵢ₋ᵢ₀ with the same waveform between TOᵢ₋ᵢ₀ and TOᵢ. In addition, the first apparatus 110 applies (430) the determined UE operation mode (i.e. waveform and power) for the next UL transmission (e.g., new waveform).

FIG. 5 illustrates a signaling chart 500 for dynamic waveform switching according to some example embodiments of the present disclosure. In the following, for the purpose of illustration, some example embodiments are described with reference to FIG. 1 with the first apparatus 110 operating as a UE, and the second apparatus 120 operating as a gNB.

The second apparatus 120 transmits (505) a configuration of second adjustment value to the first apparatus 110 via an RRC configuration. For example, this configuration of second adjustment value may comprise parameter β, and/or UL closed loop power control with P_PUSCH. At least one TOᵢ is configured such that Transform precoder indicator field is present in the DCI and parameter β may set to indicate f_{b,f,c}(i, l) at TOᵢ. The first apparatus 110 receives (510) the configuration of second adjustment value, and transmits (515) first PUSCH transmission at maximum power with CP-OFDM to the second apparatus 120. For example, the first apparatus 110 may transmit PUSCH TOᵢ₋ᵢ₀ with CP-OFDM as waveform and at maximum power for CP-OFDM. The second apparatus 120 receives (520) the first PUSCH transmission from the first apparatus 110, and transmits (525) a DCI that schedules a PUSCH transmission to be transmitted with DFT-S-OFDM to the first apparatus 110. For example, the second apparatus 120 schedules TOᵢ by transmitting DCI indicating different waveform at TO compared to TOᵢ₋ᵢ_{₀}, i.e. DFT-S-OFDM for TOᵢ.

The first apparatus 110 receives (530) the DCI and determines (535) a second transmission power. For example, the first apparatus 110 determines f_{b,f,c}(i, l) based on transmission power at TOᵢ. From TPC command of the DCI scheduling TOᵢ, the first apparatus 110 determines Σₘ₌₀^{C(D}^{ᵢ}⁾⁻¹ δ_{PUSCH,b,f,c}(m, l)≥0. The first apparatus 110 sets f_{b,f,c}(i, l)=f_{b,f,c}(i−i₀, l)+β for TOᵢ even if UE has transmitted at maximum power for TOᵢ₋ᵢ₀ with different waveform between TOᵢ₋ᵢ₀ and TOᵢ.

The first apparatus 110 applies (540) the determined UE operation mode (i.e. waveform and power) for the next UL transmission (e.g., new waveform).

FIG. 6 illustrates a signaling chart 600 for dynamic waveform switching according to some example embodiments of the present disclosure. In the following, for the purpose of illustration, some example embodiments are described with reference to FIG. 1 with the first apparatus 110 operating as a UE, and the second apparatus 120 operating as a gNB.

The second apparatus 120 transmits (605) a configuration of first adjustment value to the first apparatus 110 via an RRC configuration. For example, the configuration of first adjustment value may comprise UL closed loop power control with P_PUSCH, wherein at least one TO; is configured such that a parameter may set to indicate whether f_{b,f,c}(i, l) at TOᵢ is dependent on other factors detailed above. The first apparatus 110 receives (610) the configuration of first adjustment value and transmits (615) a first PUSCH transmission at maximum power with CP-OFDM or DFT-S-OFDM to the second apparatus 120. For example, the first apparatus 110 may transmit PUSCH TOᵢ₋ᵢ₀ with CP-OFDM as waveform and at maximum power for CP-OFDM or DFT-S-OFDM. The second apparatus 120 receives (620) the first PUSCH transmission and transmits (625) an DCI with CP-OFDM or DFT-S-OFDM to the first apparatus 110. For example, the second apparatus 120 schedules TOᵢ by transmitting DCI Transform precoder indicator field indicating different or the same or different waveform at TOᵢ compared to TOᵢ₋ᵢ_{₀}.

The first apparatus 110 receives (630) the DCI and determines (635) a second transmission power. For example, from TPC command of the DCI scheduling TOᵢ, the first apparatus 110 determines Σₘ₌₀^{C(D}^{ᵢ}⁾⁻¹ δ_{PUSCH,b,f,c}(m, l)≥0. The first apparatus 110 sets f_{b,f,c}(i, l)=f_{b,f,c}(i−i₀, l) for TOᵢ if the first apparatus 110 has transmitted at maximum power for TOᵢ₋ᵢ₀ and maximum power for TOᵢ₋ᵢ₀ is not dependent on the configured waveform (e.g., Pcmax is a factor other than the MPR, e.g., A-MPR/P-MPR) even if the same waveform between TOᵢ₋ᵢ₀ and TO; or different waveform between TOᵢ₋ᵢ₀ and TOᵢ is configured.

The first apparatus 110 applies (640) the determined UE operation mode (i.e. waveform and power) for the next UL transmission (e.g., new waveform).

FIG. 7 shows a flowchart of an example method 700 implemented at a first device in accordance with some example embodiments of the present disclosure. For the purpose of discussion, the method 700 will be described from the perspective of the first apparatus 110 in FIG. 1.

At block 710, the first apparatus 110 receives, from a second apparatus 120, a first downlink control information, DCI, and a second DCI, the first DCI scheduling a first Physical uplink shared channel, PUSCH, transmission at a first transmission occasion, TO, and the second DCI scheduling a second PUSCH transmission at a second TO subsequent to the first TO, wherein the first DCI contains a first transform precoder indicator, TPI, field whose value indicates whether a transform precoder is enabled for the first PUSCH transmission, and the second DCI contains a second TPI field whose value indicates whether a transform precoder is enabled for the second PUSCH transmission.

At block 720, the first apparatus 110 determines a transmission power for the second PUSCH transmission as a function of a second power control adjustment state, wherein at least one of the transmission power for the second PUSCH transmission or the second power control adjustment state for the second PUSCH transmission is determined based on at least one of: a first maximum transmission power at the first TO, a second maximum transmission power at the second TO, a value of the first TPI field of the first DCI, a value of the second TPI field in the second DCI or a first power control adjustment state for the first PUSCH transmission.

At block 730, the first apparatus 110 transmits the second PUSCH transmission at the determined transmission power for the second PUSCH transmission.

In some example embodiments, the method 700 further comprises: in accordance with a determination that the first apparatus reached the first maximum transmission power at the first TO, and that the value of the second TPI field of the second DCI indicates that a transform precoder is enabled for the second PUSCH transmission, determining whether the first apparatus would reach the second maximum transmission power at the second TO in the case that the second power control adjustment state is set as equal to the first power control adjustment state; and in accordance with a determination that the first apparatus would reach the second maximum transmission power at the second TO, determining the second power control adjustment state to be equal to the first power control adjustment state.

In some example embodiments, the method 700 further comprises: in accordance with a determination that the first apparatus reached the first maximum transmission power at the first TO, and that the value of the second TPI field of the second DCI indicates that a transform precoder is enabled for the second PUSCH transmission, determining whether the first apparatus would reach the second maximum transmission power at the second TO in the case that the second power control adjustment state is set as equal to the first power control adjustment state; and in accordance with a determination that the first apparatus would not reach the second maximum transmission power at the second TO, determining the second power control adjustment state to be equal to a sum of the first power control adjustment state and a first adjustment value, and determining the transmission power for the second PUSCH transmission based on the second power control adjustment state.

In some example embodiments, the method 700 further comprises: in accordance with a determination that the first apparatus reached the first maximum transmission power at the first TO, and that the value of the second TPI field of the second DCI indicates that a transform precoder is enabled for the second PUSCH transmission, determining whether the first apparatus would reach the second maximum transmission power at the second TO in the case that the second power control adjustment state is set as equal to the first power control adjustment state; and in accordance with a determination that the first apparatus would not reach the second maximum transmission power at the second TO, determining the transmission power for the second PUSCH transmission based on the second power control adjustment state and the first adjustment value, wherein the second power control adjustment state is equal to the first power control adjustment state.

In some example embodiments, the first adjustment value is at least one of the following values: a first predefined value, a first configured value that is configured via a higher-layer signaling, a first computed value determined by adding a number of transmission power control, TPC, commanding values received via DCI over a period of time, or a second computed value determined based on the first maximum transmission power and the second maximum transmission power.

In some example embodiments, the method 700 further comprises: in accordance with a determination that the first apparatus reached the first maximum transmission power at the first TO, determining whether the value of the first TPI field of the first DCI is equal to the value of the second TPI field of the second DCI; and in accordance with a determination that the value of the first TPI field of the first DCI is equal to the value of the second TPI field of the second DCI, determining the second power control adjustment state to be equal to the first power control adjustment state.

In some example embodiments, the method 700 further comprises: in accordance with a determination that the first apparatus reached the first maximum transmission power at the first TO, determining whether the value of the first TPI field of the first DCI is equal to the value of the second TPI field of the second DCI; and in accordance with a determination that the value of the first TPI field of the first DCI is different from the value of the second TPI field of the second DCI, determining the second power control adjustment state to be equal to a sum of the first power control adjustment state and a second adjustment value, and determining the transmission power for the second PUSCH transmission based on the second power control adjustment state.

In some example embodiments, the method 700 further comprises: in accordance with a determination that the first apparatus reached the first maximum transmission power at the first TO, determining whether the value of the first TPI field of the first DCI is equal to the value of the second TPI field of the second DCI; and in accordance with a determination that the value of the first TPI field of the first DCI is different from the value of the second TPI field of the second DCI, determining the transmission power for the second PUSCH transmission based on the second power control adjustment state and a second adjustment value, wherein the second power control adjustment state is equal to the first power control adjustment state.

In some example embodiments, the second adjustment value is at least one of the following values: a second predefined value, a second configured value that is configured via a higher-layer signaling, a third computed value determined by adding a number of transmission power control, TPC, commanding values received via DCI over a period of time, or a fourth computed value determined based on the first maximum transmission power and the second maximum transmission power.

In some example embodiments, the method 700 further comprises: in accordance with a determination that the first apparatus reached the first maximum transmission power at the first TO, and that the first maximum transmission power at the first TO is greater than or equal to a third maximum transmission power that would be applied by the first apparatus in case a transform precoder is enabled for the first PUSCH transmission, determining the second power control adjustment state to be equal to the first power control adjustment state.

In some example embodiments, the method 700 further comprises: in accordance with a determination that the first apparatus reached a sum of the first maximum transmission power at the first TO and a third adjustment value, determining the second power control adjustment state to be equal to the first power control adjustment state.

In some example embodiments, the third adjustment value is at least one of the following values: a third predefined value, or a third configured value that is configured via a higher-layer signaling.

In some example embodiments, the first apparatus 110 comprises a terminal device, and the second apparatus 120 comprises a network device.

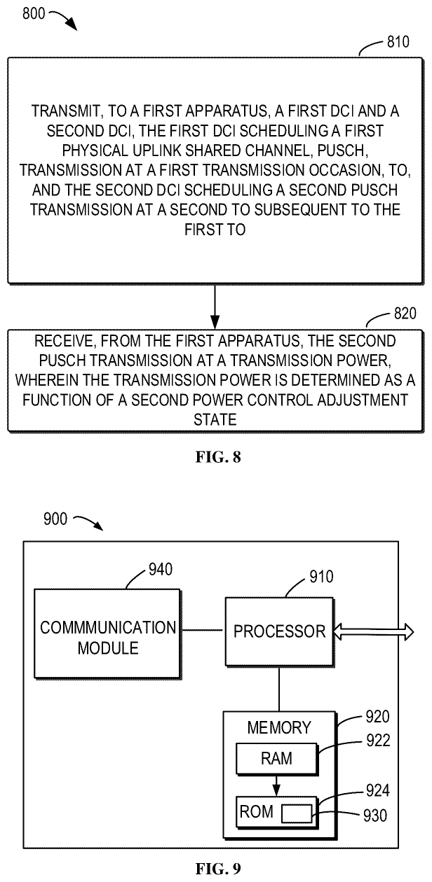

FIG. 8 shows a flowchart of an example method 800 implemented at a second device in accordance with some example embodiments of the present disclosure. For the purpose of discussion, the method 800 will be described from the perspective of the second apparatus 120 in FIG. 1.

At block 810, the second apparatus 120 transmits, to a first apparatus 110, a first downlink control information, DCI, and a second DCI, the first DCI scheduling a first Physical uplink shared channel, PUSCH, transmission at a first transmission occasion, TO, and the second DCI scheduling a second PUSCH transmission at a second TO subsequent to the first TO, wherein the first DCI contains a first transform precoder indicator, TPI, field whose value indicates whether a transform precoder is enabled for the first PUSCH transmission, and the second DCI contains a second TPI field whose value indicates whether a transform precoder is enabled for the second PUSCH transmission.

At block 820, the second apparatus 120 receives, from the first apparatus 110, the second PUSCH transmission at a transmission power for the second PUSCH transmission, wherein the transmission power for the second PUSCH transmission is determined as a function of a second power control adjustment state, and wherein at least one of the transmission power for the second PUSCH transmission or the second power control adjustment state for the second PUSCH transmission is determined based on at least one of: a first maximum transmission power at the first TO, a second maximum transmission power at the second TO, a value of the first TPI field in the first DCI, a value of the second TPI field in the second DCI or a first power control adjustment state for the first PUSCH transmission.

In some example embodiments, the method 800 further comprises: transmitting, to the first apparatus, a higher-layer signaling comprising at least one of: a first configured value for a first adjustment value, a second configured value for a second adjustment value, or a third configured value for a third adjustment value.

In some example embodiments, the first apparatus 110 comprises a terminal device, and the second apparatus 120 comprises a network device.

In some example embodiments, a first apparatus capable of performing any of the method 700 (for example, the first apparatus 110 in FIG. 1) may comprise means for performing the respective operations of the method 700. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a first DCI and a second DCI, the first DCI scheduling a first Physical uplink shared channel, PUSCH, transmission at a first TO and the second DCI scheduling a second PUSCH transmission at a second TO subsequent to the first TO, wherein the first DCI contains a first TPI field whose value indicates whether a transform precoder is enabled for the first PUSCH transmission, and the second DCI contains a second TPI field whose value indicates whether a transform precoder is enabled for the second PUSCH transmission; means for determining a transmission power for the second PUSCH transmission as a function of a second power control adjustment state, wherein at least one of the transmission power for the second PUSCH transmission or the second power control adjustment state for the second PUSCH transmission is determined based on at least one of: a first maximum transmission power at the first TO, a second maximum transmission power at the second TO, a value of the first TPI field of the first DCI, a value of the second TPI field in the second DCI or a first power control adjustment state for the first PUSCH transmission; and means for transmitting the second PUSCH transmission at the determined transmission power for the second PUSCH transmission.

In some example embodiments, the first apparatus further comprises: means for in accordance with a determination that the first apparatus reached the first maximum transmission power at the first TO, and that the value of the second TPI field of the second DCI indicates that a transform precoder is enabled for the second PUSCH transmission, determining whether the first apparatus would reach the second maximum transmission power at the second TO in the case that the second power control adjustment state is set as equal to the first power control adjustment state; and means for in accordance with a determination that the first apparatus would reach the second maximum transmission power at the second TO, determining the second power control adjustment state to be equal to the first power control adjustment state.

In some example embodiments, the first apparatus further comprises: means for in accordance with a determination that the first apparatus reached the first maximum transmission power at the first TO, and that the value of the second TPI field of the second DCI indicates that a transform precoder is enabled for the second PUSCH transmission, determining whether the first apparatus would reach the second maximum transmission power at the second TO in the case that the second power control adjustment state is set as equal to the first power control adjustment state; and in accordance with a determination that the first apparatus would not reach the second maximum transmission power at the second TO, means for determining the second power control adjustment state to be equal to a sum of the first power control adjustment state and a first adjustment value, and means for determining the transmission power for the second PUSCH transmission based on the second power control adjustment state.

In some example embodiments, the first apparatus further comprises: means for in accordance with a determination that the first apparatus reached the first maximum transmission power at the first TO, and that the value of the second TPI field of the second DCI indicates that a transform precoder is enabled for the second PUSCH transmission, determining whether the first apparatus would reach the second maximum transmission power at the second TO in the case that the second power control adjustment state is set as equal to the first power control adjustment state; and means for in accordance with a determination that the first apparatus would not reach the second maximum transmission power at the second TO, determining the transmission power for the second PUSCH transmission based on the second power control adjustment state and the first adjustment value, wherein the second power control adjustment state is equal to the first power control adjustment state.

In some example embodiments, the first adjustment value is at least one of the following values: a first predefined value, a first configured value that is configured via a higher-layer signaling, means for a first computed value determined by adding a number of transmission power control, TPC, commanding values received via DCI over a period of time, or a second computed value determined based on the first maximum transmission power and the second maximum transmission power.

In some example embodiments, the first apparatus further comprises: means for in accordance with a determination that the first apparatus reached the first maximum transmission power at the first TO, determining whether the value of the first TPI field of the first DCI is equal to the value of the second TPI field of the second DCI; and means for in accordance with a determination that the value of the first TPI field of the first DCI is equal to the value of the second TPI field of the second DCI, determining the second power control adjustment state to be equal to the first power control adjustment state.

In some example embodiments, the first apparatus further comprises: means for in accordance with a determination that the first apparatus reached the first maximum transmission power at the first TO, determining whether the value of the first TPI field of the first DCI is equal to the value of the second TPI field of the second DCI; and in accordance with a determination that the value of the first TPI field of the first DCI is different from the value of the second TPI field of the second DCI, means for determining the second power control adjustment state to be equal to a sum of the first power control adjustment state and a second adjustment value, and means for determining the transmission power for the second PUSCH transmission based on the second power control adjustment state.

In some example embodiments, the first apparatus further comprises: means for in accordance with a determination that the first apparatus reached the first maximum transmission power at the first TO, determining whether the value of the first TPI field of the first DCI is equal to the value of the second TPI field of the second DCI; and means for in accordance with a determination that the value of the first TPI field of the first DCI is different from the value of the second TPI field of the second DCI, determining the transmission power for the second PUSCH transmission based on the second power control adjustment state and a second adjustment value, wherein the second power control adjustment state is equal to the first power control adjustment state.

In some example embodiments, the second adjustment value is at least one of the following values: a second predefined value, a second configured value that is configured via a higher-layer signaling, means for a third computed value determined by adding a number of transmission power control, TPC, commanding values received via DCI over a period of time, or a fourth computed value determined based on the first maximum transmission power and the second maximum transmission power.

In some example embodiments, the first apparatus further comprises: means for in accordance with a determination that the first apparatus reached the first maximum transmission power at the first TO, and that the first maximum transmission power at the first TO is greater than or equal to a third maximum transmission power that would be applied by the first apparatus in case a transform precoder is enabled for the first PUSCH transmission, determining the second power control adjustment state to be equal to the first power control adjustment state.

In some example embodiments, the first apparatus further comprises: means for in accordance with a determination that the first apparatus reached a sum of the first maximum transmission power at the first TO and a third adjustment value, determining the second power control adjustment state to be equal to the first power control adjustment state.

In some example embodiments, the third adjustment value is at least one of the following values: a third predefined value, or a third configured value that is configured via a higher-layer signaling.

In some example embodiments, the first apparatus comprises a terminal device, and the second apparatus comprises a network device.

In some example embodiments, the first apparatus further comprises means for performing other operations in some example embodiments of the method 700 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 800 (for example, the second apparatus 120 in FIG. 1) may comprise means for performing the respective operations of the method 800. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a first DCI and a second DCI, the first DCI scheduling a first PUSCH transmission at a first TO and the second DCI scheduling a second PUSCH transmission at a second TO subsequent to the first TO, wherein the first DCI contains a first TPI field whose value indicates whether a transform precoder is enabled for the first PUSCH transmission, and the second DCI contains a second TPI field whose value indicates whether a transform precoder is enabled for the second PUSCH transmission; and means for receiving, from the first apparatus, the second PUSCH transmission at a transmission power for the second PUSCH transmission, wherein the transmission power for the second PUSCH transmission is determined as a function of a second power control adjustment state, and wherein at least one of the transmission power for the second PUSCH transmission or the second power control adjustment state for the second PUSCH transmission is determined based on at least one of: a first maximum transmission power at the first TO, a second maximum transmission power at the second TO, a value of the first TPI field in the first DCI, a value of the second TPI field in the second DCI or a first power control adjustment state for the first PUSCH transmission.

In some example embodiments, the second apparatus further comprises: means for transmitting, to the first apparatus, a higher-layer signaling comprising at least one of: a first configured value for a first adjustment value, a second configured value for a second adjustment value, or a third configured value for a third adjustment value.

In some example embodiments, the first apparatus comprises a terminal device, and the second apparatus comprises a network device.

In some example embodiments, the second apparatus further comprises means for performing other operations in some example embodiments of the method 800 or the second apparatus 120. In some example embodiments, the means comprises at least one processor; and at least one memory storing instructions that, when executed by the at least one processor, cause the performance of the second apparatus.

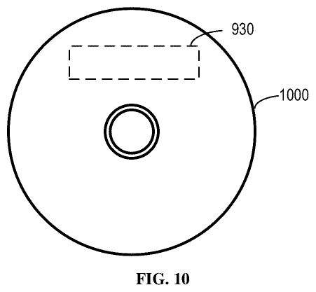

FIG. 9 is a simplified block diagram of a device 900 that is suitable for implementing example embodiments of the present disclosure. The device 900 may be provided to implement a communication device, for example, the first apparatus 110 or the second apparatus 120 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first apparatus comprising:
at least one processor; and
at least one memory storing instructions that, when executed by the at least one processor, cause the first apparatus at least to:
receive, from a second apparatus, a first downlink control information (DCI) and a second DCI, the first DCI scheduling a first Physical uplink shared channel (PUSCH) transmission at a first transmission occasion (TO), and the second DCI scheduling a second PUSCH transmission at a second TO subsequent to the first TO, wherein the first DCI contains a first transform precoder indicator (TPI) field whose value indicates whether a transform precoder is enabled for the first PUSCH transmission, and the second DCI contains a second TPI field whose value indicates whether a transform precoder is enabled for the second PUSCH transmission;
determine a transmission power for the second PUSCH transmission as a function of a second power control adjustment state, wherein at least one of the transmission power for the second PUSCH transmission or the second power control adjustment state for the second PUSCH transmission is determined based on at least one of: a first maximum transmission power at the first TO, a second maximum transmission power at the second TO, a value of the first TPI field of the first DCI, a value of the second TPI field in the second DCI or a first power control adjustment state for the first PUSCH transmission; and
transmit the second PUSCH transmission at the determined transmission power for the second PUSCH transmission.

2.-21. (canceled)
